(19) United States
(12) Patent Application Publication
(10) Pub. No.: US 2005/0011925 A1
(43) Pub. Date: Jan. 20, 2005

(54) Method of and apparatus for cracking connecting rod

(76) Inventors: Yasuo Momose, Utsunomiya-shi (JP); Sigeo Ota, Kawachi-gun (JP); Tomohiko Yamamoto, Mooka-shi (JP)

Correspondence Address: BIRCH STEWART KOLASCH & BIRCH, PO BOX 747, FALLS CHURCH, VA, 22040-0747, US

(21) Appl. No.: 10/891,144

(22) Filed: Jul. 15, 2004

(30) Foreign Application Priority Data
Jul. 16, 2003 (JP) 2003-275067

(51) Int. Cl. B26F 3/00

(52) U.S. Cl. 225/1; 225/103; 225/93

(57) ABSTRACT

A preload is applied to a wedge pressed in between a pair of spreaders by a preloading mechanism to press the spreaders against an inner surface of a joint hole defined in a larger end of a connecting rod. While the spreaders are pressed against the inner surface of the joint hole, a movable table with weights placed thereon is caused to drop into impingement against a flange coupled to an end of a shaft. The shaft is pulled downwardly to apply an impact load to the wedge, which is coupled to the shaft, in the direction in which the wedge is pressed in, thereby fracturing the larger end into a cap and a rod.

### BACKGROUND OF THE INVENTION

1. Field of the Invention

The present invention relates to a method of and an apparatus for cracking a connecting rod as an engine component for vehicles, and more particularly to a method of and an apparatus for cracking a one-piece connecting rod having a larger end and a smaller end to fracture the larger end into a cap and a rod.

2. Description of the Related Art

Heretofore, connecting rods interconnecting piston pins and crank pins have widely been used in vehicular engines. Each of the connecting rods has a larger end coupled to the crankpin and a smaller end coupled to the piston pin. For manufacturing a connecting rod, it is generally customary to produce a one-piece connecting rod having a larger and a smaller end and thereafter to fracture the larger end into a cap and a rod.

One conventional process of fracturing a connecting rod will be described below.

As shown in FIG. 8 of the accompanying drawings, a one-piece connecting rod 5 includes a shank 1 having a smaller end 2 and a larger end 3 with a cap 4 integrally formed therewith. The connecting rod 5 is held by a pair of jigs 6, 7 fixed to each other with the larger end 3 and the cap 4 being retained therein. A pressurizing hose 8 is inserted in a larger end hole 3a defined in the larger end 3 and supplied with a pressurizing liquid under pressure to applying a constant static pressure to the entire inner surface of the larger end hole 3a. Under the applied pressure, the larger end 3 is fractured from cracking slots 9 that are defined in the inner surface of the larger end hole 3a. The larger end 3 is fractured into the cap 4 and the shank 1 without suffering undue strains. If a plurality of connecting rods 5 and a plurality of sets of jigs 6, 7 are arranged on the pressurizing hose 8, then many connecting rods 5 can simultaneously be cracked. For details, reference should be made to Japanese Laid-Open Patent Publication No. 11-245122, for example.

According to the disclosed process, however, since a plurality of connecting rods 5 and a plurality of sets of jigs 6, 7 are arranged on the pressurizing hose 8, the entire apparatus for cracking the connecting rods 5 needs to be large in size in the direction of the array of connecting rods 5 and jigs 6, 7. The apparatus is also complex because of ancillary equipment required to supply and discharge the pressurizing liquid. Therefore, the apparatus is inevitably costly to manufacture.

The cracking process disclosed in the above publication makes it possible to process a number of connecting rods at the same time. However, before the connecting rods 5 are cracked, it is necessary to insert the pressurizing hose 8 into the larger end holes 3a in the connecting rods 5. As the number of connecting rods 5 to be processed increases, the operation to insert the pressurizing hose 8 through the larger end holes 3a in the connecting rods 5 becomes more tedious and time-consuming, resulting in a reduction in the production efficiency with which to crack the connecting rods 5.

### SUMMARY OF THE INVENTION

It is a general object of the present invention to provide a method of and an apparatus for cracking a connecting rod with a simplified and inexpensive overall apparatus structure and an increased production efficiency.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1A is a perspective view of a connecting rod to which the present invention is applied;

FIG. 1B is a perspective view of the connecting rod as it is fractured into a cap and a rod;

FIG. 2 is a front elevational view, partly in cross section, of a cracking apparatus according to an embodiment of the present invention;

FIG. 3 is an enlarged fragmentary plan view of the cracking apparatus;

FIG. 4 is a perspective view of a workpiece holding mechanism of the cracking apparatus;

FIG. 5A is an enlarged fragmentary plan view of a fracturing mechanism of the cracking apparatus;

FIG. 5B is an enlarged fragmentary cross-sectional view of the fracturing mechanism;

FIG. 6 is an enlarged front elevational view, partly in cross section, showing the manner in which the fracturing mechanism is preloaded by a preloading mechanism of the cracking apparatus;

FIG. 7 is an enlarged front elevational view, partly in cross section, showing the manner in which an impact load is applied to the fracturing mechanism by the preloading mechanism; and

FIG. 8 is a cross-sectional view illustrative of a conventional process of fracturing a connecting rod.

### DESCRIPTION OF THE PREFERRED EMBODIMENT

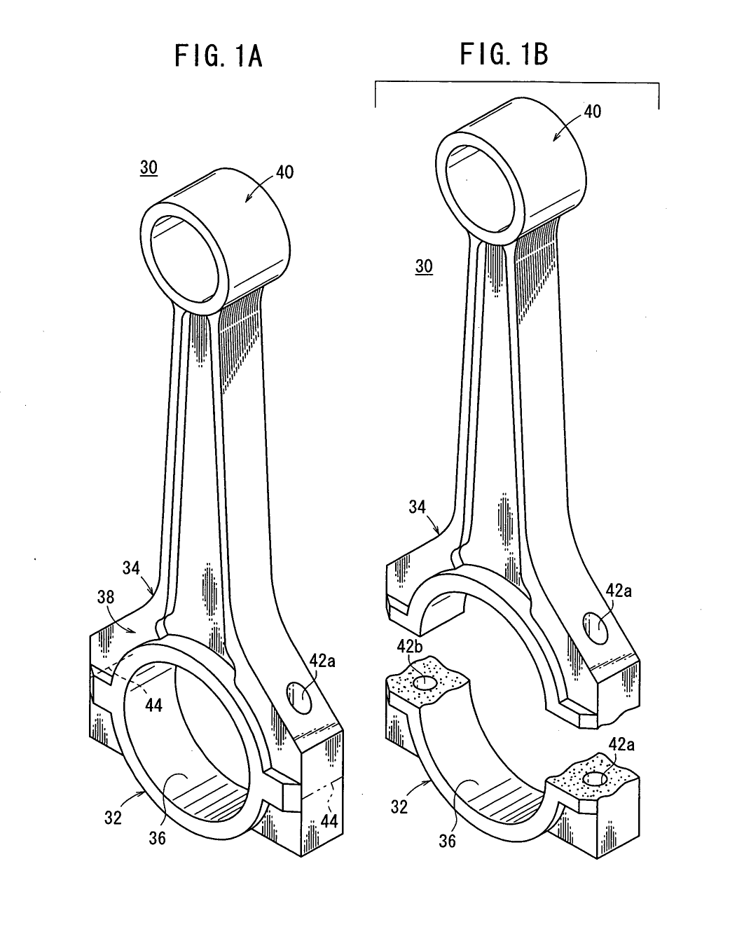

FIG. 1A shows in perspective a connecting rod 30 as a workpiece to which the present invention is applied, and FIG. 1B shows in perspective the connecting rod 30 as it is fractured into a cap 32 and a rod 34.

As shown in FIGS. 1A and 1B, the connecting rod 30 has a larger end 38 comprising an integral structure of the cap 32 and the rod 34 with a substantially circular joint hole 36 defined therebetween, and a smaller end 40 positioned remotely from the larger end 38. The connecting rod 30 may be integrally produced by casting, forging, or the like.

The larger end 38 has a pair of bolt holes 42a, 42b defined in opposite sides thereof by a boring means such as a drill or the like. In a process of assembling an engine, bolts (not shown) are threaded from the cap 32 into the respective bolt holes 42a, 42b, fastening the cap 32 to the rod 34. The fractured cap 32 is thus fastened to the rod 34 to connect the larger end 38 of the connecting rod 30 to a crank pin of the engine.

In FIG. 1A, reference numeral 44 indicates a cracking area on the larger end 38, positioned as a boundary area between the cap 32 and the rod 34. The cracking area 44 is located in the opposite sides of the larger end 38 diametrically across the joint hole 36.

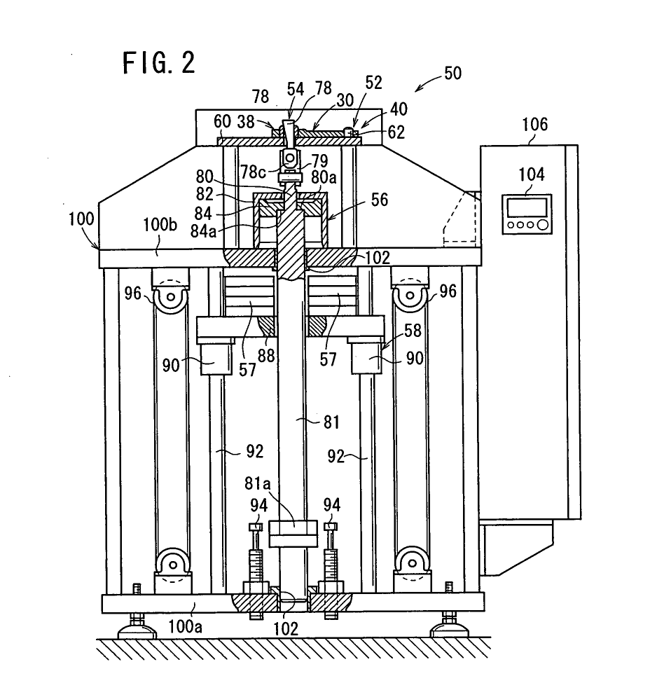

FIGS. 2 through 4 show a cracking apparatus 50 for cracking the connecting rod 30 according to an embodiment of the present invention. The cracking apparatus 50 comprises a workpiece holding mechanism 52 for setting the connecting rod 30 thereon and holding the connecting rod 30, a fracturing mechanism 54 for fracturing the larger end 38 of the connecting rod 30, a preloading mechanism 56 for preloading the fracturing mechanism 54, and a loading mechanism 58 for applying an impact load to the fracturing mechanism 54 by dropping weights (heavy objects) 57.

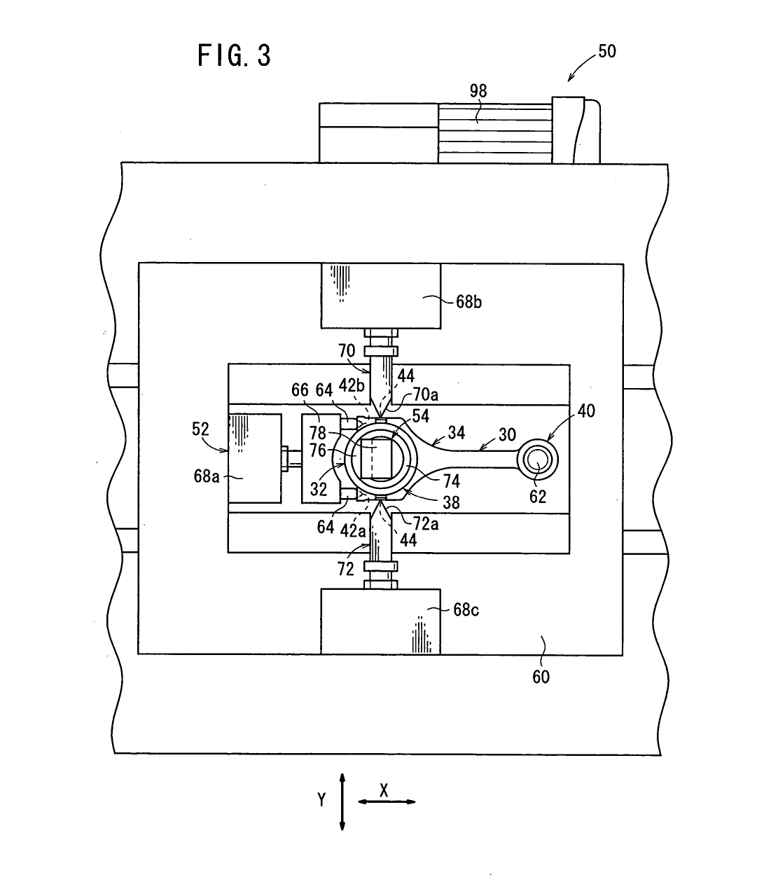

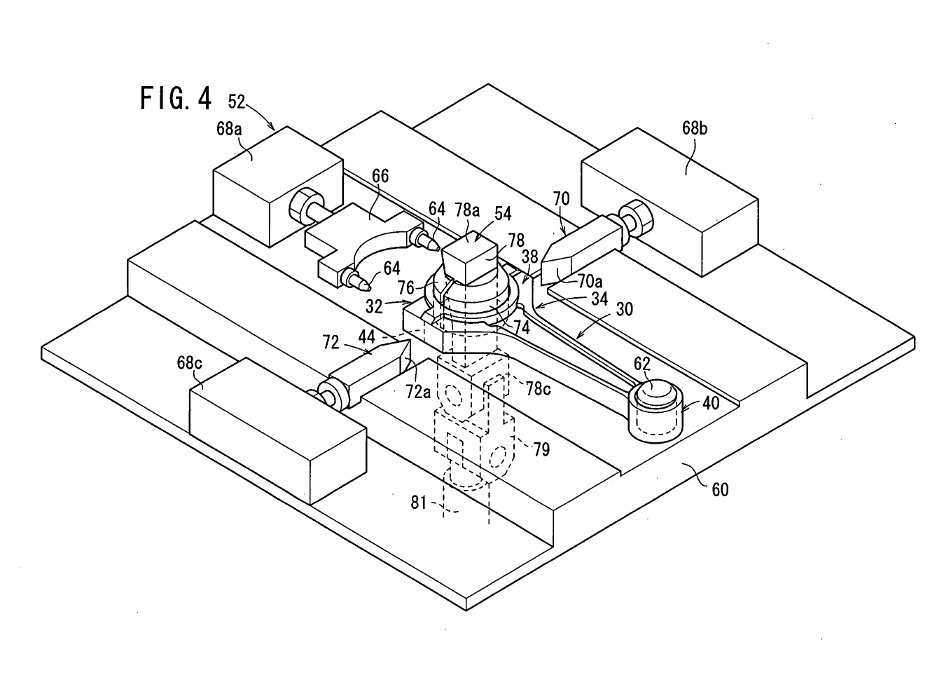

As shown in FIGS. 3 and 4, the workpiece holding mechanism 52 comprises a support base 60 for supporting the connecting rod 30 thereon, a fixing pin 62 for positioning and fixing the connecting rod 30 at its smaller end 40, and a pair of slide pins 64 oriented toward the bolt holes 42a, 42b for holding the connecting rod 30 at its larger end 38 laterally in the direction indicated by the arrow X in FIG. 3.

The slide pins 64 are connected to a hydraulic cylinder 68a by a slide plate 66. The hydraulic cylinder 68a is used to reliably hold the connecting rod 30 at its larger end 38 and also to prevent the cap 32 fractured from the larger end 38 reliably from being scattered around. In the present embodiment, the hydraulic cylinder 68a applies a load adjustable in the range from about 0 to 490 newtons (N), for example, to the connecting rod 30.

As shown in FIG. 3, the workpiece holding mechanism 52 may have a pair of pressers 70, 72 for pressing the cracking area 44 of the larger end 38 from its opposite sides in the direction indicated by the arrow Y. The pressers 70, 72 have respective sharply pointed abutment edges 70a, 72a on ends thereof. The pressers 70, 72 have opposite ends coupled to respective hydraulic cylinders 68b, 68c remotely from the abutment edges 70a, 72a.

The fracturing mechanism 54 has a pair of spreaders 74, 76 for being set in the joint hole 36 in the larger end 38, and a wedge 78 which is pressed in between the spreaders 74, 76 for spreading the spreaders 74, 76 away from each other.

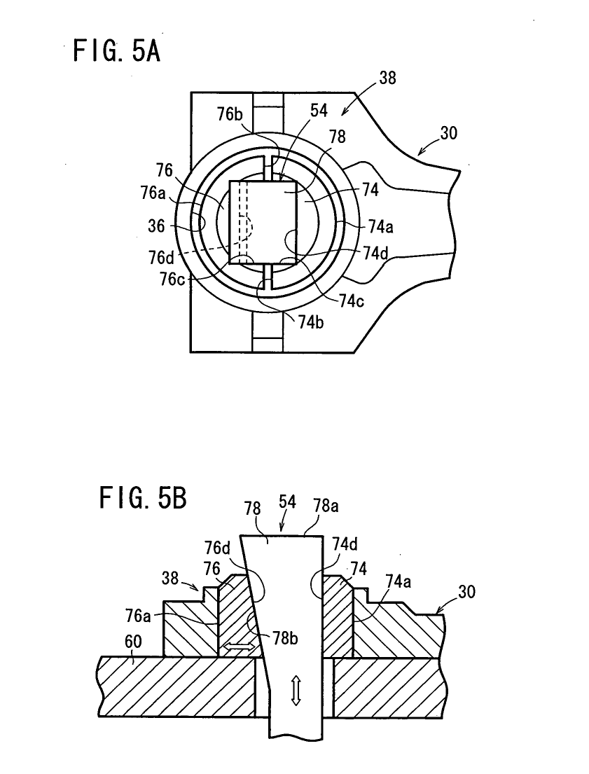

As shown in FIGS. 5A and 5B, the spreaders 74, 76 are each of a substantially semicircular shape in plan, and have respective arcuate portions 74a, 76a and respective straight portions 74b, 76b. The arcuate portions 74a, 76a have a curvature which is substantially identical to the curvature of the inner surface of the joint hole 36, and can substantially be pressed against the inner surface of the joint hole 36. The straight portions 74b, 76b have respective recesses 74c, 76c defined centrally therein for receiving the wedge 78 therein. Of these recesses 74c, 76c, the recess 74c has a wall 74d generally shaped as an upstanding wall, and the other recess 76c has a wall 76d shaped as a tapered wall that is progressively inclined outwardly in the upward direction (see FIG. 5B).

The wedge 78 has a tapered surface 78b on one side thereof that is progressively inclined outwardly in the upward direction toward an upper end 78a of the wedge 78. The wedge 78 is fitted in the recesses 74c, 76c such that the tapered surface 78b is held in sliding contact with the tapered wall 76d of the spreader 76. When the wedge 78 is urged (pulled) downwardly, the tapered surface 78b slides against the tapered wall 76d, forcing the spreader 76 to move away from the other spreader 74.

As shown in FIG. 2, the preloading mechanism 56 has a hydraulic cylinder 82 for producing a preload to be applied to the wedge 78. The hydraulic cylinder 82 comprises a piston rod (load transmitter) 80 coupled to the lower end 78c of the wedge 78 by a joint 79 such as a joint pin or the like, and a piston 84 having a step 84a engaging an annular step surface 80a of the piston rod 80.

The piston rod 80 extends centrally through the piston 84 and is slidable with respect to the piston 84. The piston 84 of the hydraulic cylinder 82 is displaceable in unison with the piston rod 80 in the direction in which the wedge 78 is pressed in, i.e., pulled downwardly. The piston 84 is also movable with respect to the piston rod 80 in a direction opposite to the direction in which the wedge 78 is pressed in. Stated otherwise, the hydraulic cylinder 82 causes the piston 84 to apply a preload to the fracturing mechanism 54 only in one longitudinal direction of the piston rod 80. The preload applied to the wedge 78 is adjustable in the range from about 0 to 49 kN, for example.

The preloading mechanism 56 and the loading mechanism 58 have a common load transmitting shaft (load transmitter) 81 coupled to the wedge 78 by the piston rod 80. The shaft 81 has an end integral with the piston rod 80 at the step surface 80a. The other end of the shaft 81 has a flange 81a that is positionally adjustable in the axial direction of the shaft 81.

The loading mechanism 58 has a movable table 88 supporting weights 57 thereon for generating an impact load to be applied to the wedge 78 through the shaft 81 when the movable table 88 impinges downwardly upon the flange 81a, and a pair of guide shafts 92 extending through the movable table 88 which is slidably supported on the guide shafts 92 by guide bushings 90. In the present embodiment, the impact load applied to the wedge 78 is adjustable in the range from about 49 to 186 kN, for example.

The loading mechanism 58 also has a pair of stops 94 for adjusting the lower limit of the stroke of downward movement of the movable table 88, a pair of belt-and-pulley mechanisms 96 for returning the movable table 88 which has dropped to an upper standby position, and a motor 98 (see FIG. 3) for actuating the belt-and-pulley mechanisms 96. The stops 94 include springs, air cushions, or the like for reducing shocks imposed on the movable table 88 when the movable table 88 drops onto the flange 81a.

As shown in FIG. 2, the above components of the cracking apparatus 50 are housed in a casing 100. The shaft 81 is axially slidably supported and limited against radial movement by bushings 102 mounted in lower and upper end plates 100a, 100b.

The casing 100 supports thereon a control/display console 104 for allowing the operator to operate the cracking apparatus 50 and to enter desired data, and also for displaying operating statuses of the cracking apparatus 50 and entered data. The control/display console 104 is connected to a control board 106 which controls the cracking apparatus 50 as a whole.

The cracking apparatus 50 according to the present invention is basically constructed as described above. Operation of the cracking apparatus 50 for carrying out a method of cracking a connecting rod according to the present invention will be described below.

First, the one-piece connecting rod 30 is set on the support base 60 of the workpiece holding mechanism 52 (see FIG. 4). At this time, the connecting rod 30 is positioned at the smaller end 40 by the fixing pin 62 with the spreaders 74, 76 fitted in the joint hole 36 in the larger end 38.

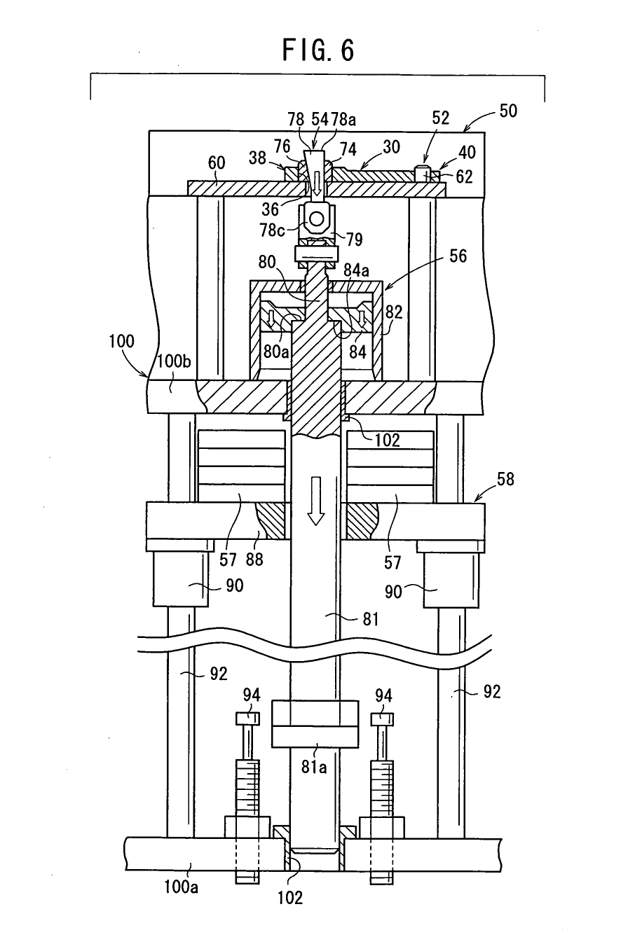

Then, the hydraulic cylinder 82 is actuated to move the piston 84 downwardly, causing the step surface 80a engaging the step 84a to move the piston rod 80 downwardly (see FIG. 6). At the same time, the wedge 78 coupled to the piston rod 80 is urged downwardly and hence is preloaded. The wedge 78 is now pressed into the recesses 74c, 76c in the spreaders 74, 76. The spreader 76 is displaced outwardly away from the spreader 74 as the wall 76d slides against the tapered surface 78b of the wedge 78. The spreaders 74, 76 are pressed against the inner surface of the joint hole 36 in the larger end 38.

The preload applied to the wedge 78 is adjusted in the above range (from about 0 to 49 kN) to the extent that even though the spreaders 74, 76 are pressed against the inner surface of the joint hole 36, the larger end 38 is not fractured, i.e., is elastically deformable. The larger end 38 and the spreaders 74, 76 are free of wobbling movement, but the connecting rod 30 is reliably retained in place by the spreaders 74, 76.

Then, the hydraulic cylinders 68b, 68c are actuated to cause the sharply pointed abutment edges 70a, 72a of the pressers 70, 72 to engage and press the larger end 38 from its opposite sides at the cracking area 44 in the directions indicated by the arrows Y in FIG. 3. When the sharply pointed abutment edges 70a, 72a press the larger end 38, stresses are concentrated on the cracking area 44. Substantially at the same time, the hydraulic cylinder 68a is actuated to insert the slide pins 64 into the respective bolt holes 42a, 42b to hold the connecting rod 30 laterally from the side of the larger end 38 in the direction indicated by the arrow X in FIG. 3.

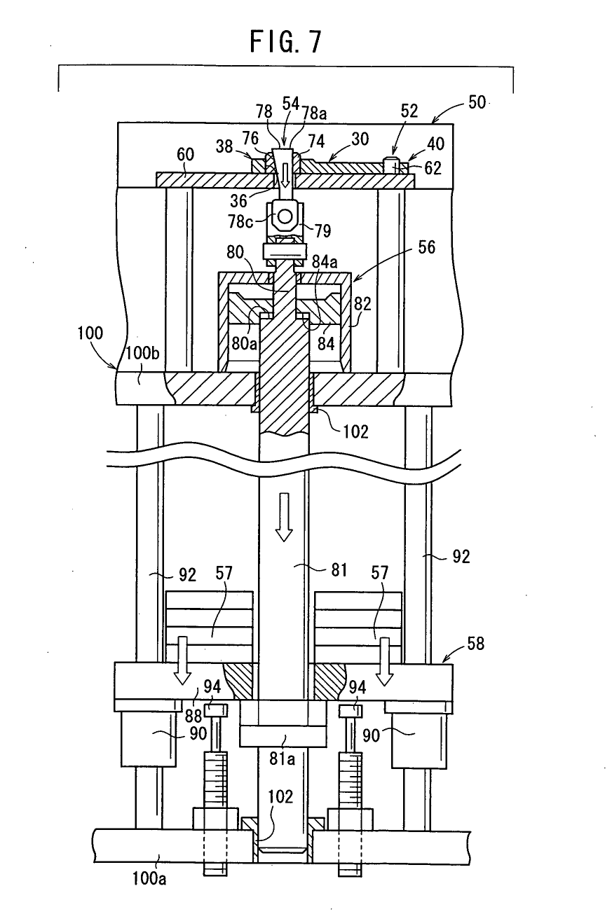

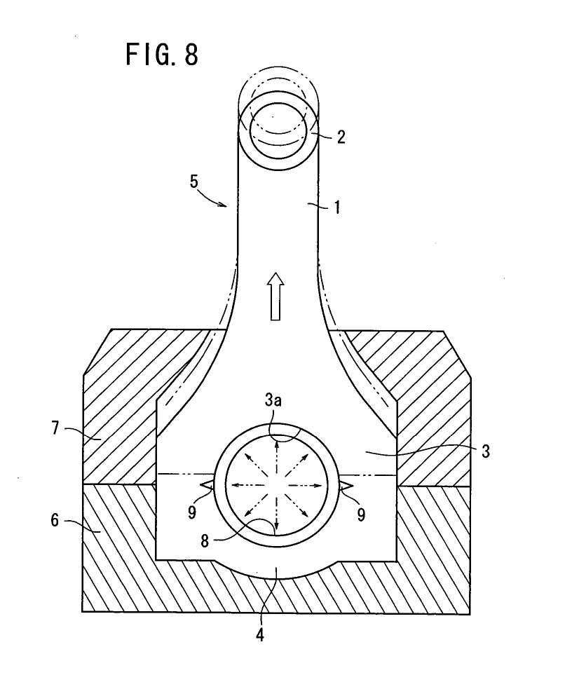

Then, the movable table 88 with the weights 57 supported thereon is dropped while being guided by the guide shafts 92, and impinges upon the flange 81a of the shaft 81, which is displaced downwardly to apply an impact load to the wedge 78 (see FIG. 7). At this time, since the piston 84 of the hydraulic cylinder 82 is movable with respect to the shaft 81 in the direction opposite to the direction in which the wedge 78 is pressed in, i.e., in the direction opposite to the direction in which the impact load is applied to the wedge 78, the impact load is reliably applied to the wedge 78 without being dampened by the hydraulic cylinder 82.

The wedge 78 is therefore further pressed into the recesses 74c, 74c in the spreaders 74, 76. The spreader 76 is displaced outwardly further away from the spreader 74 as the wall 76d slides against the tapered surface 78b of the wedge 78. The larger end 38 is now subjected to stresses greater than the elastically deformable limit thereof, and hence is fractured into the cap 32 and the rod 34 at the cracking area 44 on which stresses have been concentrated by the pressers 70, 72 (see FIG. 1B). At this time, the fractured cap 32 is prevented from being scattered around because it is retained by the slide pins 64 urged by the hydraulic cylinder 68 (see FIG. 3).

As described above, with the cracking apparatus for cracking the connecting rod 30 and the method of cracking the connecting rod 30, according to an embodiment of the present invention, the wedge 78 is preloaded by the preloading mechanism 56 to press the spreaders 74, 76 against the inner surface of the joint hole 36 in the larger end 38 of the connecting rod 30. Since the larger end 38 is reliably held in place by the spreaders 74, 76 and is prevented from making wobbling movement, any strains that the larger end 38 tend to suffer when it is fractured are reduced as much as possible, and hence the cap 32 and the rod 34 which are separated from the larger end 38 are stably circular in shape when combined.

For fracturing the larger end 38, the movable table 88 with the weights 58 placed thereon are dropped by the loading mechanism 58 to apply an impact load to the wedge 78 in the direction in which the wedge 78 is pressed in. The loading mechanism 58 is effective to make the cracking apparatus 50 simpler in structure and lower in cost than the conventional cracking apparatus. Inasmuch as the larger end 38 is fractured by setting the connecting rod 30 on the spreaders 74, 76 and then dropping the movable table 88 with the weights 58 placed thereon, a tedious and time-consuming cracking process, as has been conventionally used, is not required. As a result, the tact time, i.e. production cycle time, is shortened, making it possible to produce the connecting rod 30 with increased efficiency.

The preloading mechanism 56 and the loading mechanism 58 have the common shaft 81 that is coupled to the wedge 78 by the piston rod 80. Since the preload generated by the preloading mechanism 56 and the impact load generated by the loading mechanism 58 are transmitted to the wedge 78 by the common shaft 81, the preload and the impact load can easily and reliably be applied to the wedge 78 with a simple arrangement which makes the cracking apparatus 50 simple in construction.

The cracking area 44 as a boundary area between the cap 32 and the rod 34 of the larger end 38 is pressed by the pressers 70, 72. Therefore, the larger end 38 can reliably be fractured at the cracking area 44 without the need for slots, notches, or the like, which otherwise have been used conventionally. As a result, no process is required to form such slots, notches, or the like in the larger end 38, and hence the production efficiency with which to crack the connecting rod 30 is increased.

In the above embodiment, the preloading mechanism 56 includes the hydraulic cylinder 82. However, the preloading mechanism 56 may employ weights lighter than the weights 57, or elastic members such as springs, for generating the preload.

Although a certain preferred embodiment of the present invention has been shown and described in detail, it should be understood that various changes and modifications may be made therein without departing from the scope of the appended claims.

1. An apparatus for cracking a one-piece connecting rod having a larger end and a smaller end by setting a larger end hole defined in the larger end over a pair of spreaders and pressing a wedge in between said spreaders to move the spreaders away from each other, thereby fracturing said larger end into a cap and a rod, comprising:
a preloading mechanism for applying a preload to said wedge in the direction in which said wedge is pressed in to press said spreaders against an inner surface of said larger end hole in said larger end; and
a loading mechanism for applying an impact load to said wedge in the direction in which said wedge is pressed in to fracture said larger end, by dropping a heavy object.

2. An apparatus according to claim 1, wherein said preloading mechanism and said loading mechanism have a common load transmitter coupled to said wedge.

3. An apparatus according to claim 2, wherein said load transmitter comprises:
a shaft having a flange to which said impact load is applied by dropping said heavy object;
said preloading mechanism comprising a cylinder having a piston rod for transmitting said impact load to said wedge, said shaft being integral with said piston rod.

4. An apparatus according to claim 1, wherein said preloading mechanism comprises a cylinder for applying said preload;
said cylinder having a piston rod transmitting said impact load to said wedge and a piston which is displaceable in unison with said piston rod in the direction in which said wedge is pressed in and which is movable with respect to said piston rod in a direction opposite to the direction in which said wedge is pressed in.

5. An apparatus according to claim 4, wherein said piston rod is slidably movable centrally through said piston.

6. An apparatus according to claim 3, further comprising:
a movable table supporting said heavy object thereon;
wherein under a force of gravity exerted by said heavy object, said movable table drops into impingement against a flange on an end of said shaft to generate the impact load to be applied to said wedge.

7. An apparatus according to claim 6, further comprising:
a guide shaft, said movable table being slidably supported by said guide shaft.

8. An apparatus according to claim 6, further comprising:
a stop for adjusting a lower limit of a stroke of dropping movement of said movable table.

9. An apparatus according to claim 6, further comprising:
a belt-and-pulley mechanism for returning said movable table which has dropped to an upper standby position.

10. An apparatus according to claim 1, further comprising:
a workpiece holding mechanism for holding said connecting rod;
said workpiece holding mechanism comprising a support base for supporting the connecting rod thereon, a fixing pin for positioning and fixing the connecting rod at said smaller end, a slide pin for holding the connecting rod at said larger end, and a hydraulic cylinder fixedly mounted on said support base;
said slide pin being displaceable by said hydraulic cylinder.

11. A method of cracking a one-piece connecting rod having a larger end and a smaller end by setting a larger end hole defined in the larger end over a pair of spreaders and pressing a wedge in between said spreaders to move the spreaders away from each other, thereby fracturing said larger end into a cap and a rod, comprising the steps of:
applying a preload to said wedge in the direction in which said wedge is pressed in to press said spreaders against an inner surface of said larger end hole in said larger end; and
applying an impact load to said wedge in the direction in which said wedge is pressed in to fracture said larger end, by dropping a heavy object.

12. A method according to claim 11, further comprising the steps of:
before said impact load is applied to said wedge, pressing a pair of pressers having respective sharply pointed abutment edges against a cracking area as a boundary area between said cap and said rod in said larger end, and thereafter fracturing said larger end.
